(19) United States
(12) Patent Application Publication
(10) Pub. No.: US 2012/0087163 A1
(43) Pub. Date: Apr. 12, 2012

(54) POWER SUPPLY APPARATUS

(75) Inventors: Takeshi Morimoto, Osaka-shi (JP); Tetsuro Ikeda, Osaka-shi (JP)

(73) Assignee: SANSHA ELECTRIC MANUFACTURING COMPANY, LIMITED, Osaka-shi (JP)

(21) Appl. No.: 12/974,050

(22) Filed: Dec. 21, 2010

(30) Foreign Application Priority Data
Oct. 6, 2010 (JP) 2010-226274

(51) Int. Cl. H02M 7/219

(52) U.S. Cl. 363/71

(57) ABSTRACT

A relay contact is connected between positive power supply input terminals of first and second inverters, and a relay contact is connected between negative power supply input terminals of the inverters. A positive DC power supply terminal is connected to the positive power supply input terminal of the first inverter, and a negative DC power supply terminal is connected to the negative power supply input terminal of the second inverter. A drive unit opens or closes the relay contacts when a voltage appearing between the positive and negative DC power supply terminals is larger than a predetermined value or is not larger than the predetermined value, respectively. A diode has its anode and cathode connected to the negative power supply input terminal of the first inverter the positive power supply input terminal of the second inverter, respectively.

### TECHNICAL FIELD

This invention relates to a power supply apparatus and, more particularly, to a power supply apparatus having two inverters used therein.

### BACKGROUND ART

Examples of a power supply apparatus having two inverters used therein are described in, for example, U.S. Pat. No. 5,930,122 and U.S. Pat. No. 7,339,807. The power supply apparatuses disclosed in these U.S. patents are arranged to be operable from an AC supply voltage of either of the 200 V level and the 400 V level. The power supply apparatuses use relays to switch the two, first and second, inverters between the state in which they are connected in series and the state in which they are connected in parallel. More specifically, each inverter has two, namely, positive and negative, power supply input terminals, and the positive power supply input terminals of the two inverters are connected together via a first relay contact. The negative power supply input terminals of the inverters are connected together via a second relay contact. The negative power supply input terminal of the first inverter is connected to the positive power supply input terminal of the second inverter via a third relay contact. A DC voltage resulting from rectifying an AC voltage in a rectifying circuit is applied between the positive power supply input terminal of the first inverter and the negative power supply input terminal of the second inverter. When the power supply apparatus is operated from a 200 V level AC voltage, the third relay contact is opened and the first and second relay contacts are closed so that the two inverters are connected in parallel with each other, and the DC voltage from the rectifying circuit is applied to the two inverters connected in parallel. When the power supply apparatus is operated from a 400 V level AC voltage, the first and second relay contacts are opened with the third relay contact closed, to thereby connect the two inverters in series with each other, and the DC voltage from the rectifying circuit is applied to the two inverters connected in series.

The above-described technologies, however, use mechanical switches, such as relay contacts. The closed or opened relay contacts could be temporarily opened or closed when a casing housing the power supply apparatus falls or when strong impacts or shakings are given to the casing. When, for example, a 200 V level voltage is being applied to the power supply apparatus, with the first and second relay contacts closed and with the third relay contact opened, if the third relay contact is closed even only for an instant, all of the positive and negative power supply input terminals of the two inverters are connected in series. This causes the first through third relay contacts and the rectifying circuit to be damaged instantly. When a 400 V level AC voltage is being applied, with the first and second relay contacts opened and with the third relay contact closed, if either one of the first and second relay contacts, e.g. the first relay contact, is closed only for an instant, one of the inverters, the first inverter in the described cased, is short-circuited, which causes the first and third relay contacts to be damaged.

An object of the present invention is to provide a power supply apparatus which is not damaged or not adversely affected by undesirable operation of mechanical switches used in the power supply apparatus which would be caused by impact or shaking given to the power supply apparatus or by falling down of the apparatus.

### DISCLOSURE OF THE INVENTION

A power supply apparatus according to an embodiment of the present invention has first and second inverters. Each of the first and second inverters has a power supply input terminal of first polarity and a power supply input terminal of second polarity. The first and second inverters may be of a full-bridge type or of a half-bridge type. A first mechanical contact is connected between the first-polarity power supply input terminals of the first and second inverters, and a second mechanical contact is connected between the second-polarity power supply input terminals of the first and second inverters. The first and second mechanical contacts may be relay contacts, for example. A first DC power supply terminal is connected to the first-polarity power supply input terminal of the first inverter, and a second DC power supply terminal is connected to the second-polarity power supply input terminal of the second inverter. A DC voltage is applied between the first and second DC power supply terminals. Driving means causes the first and second mechanical contacts to be opened when the DC voltage has a value larger than a predetermined value, and causes the first and second mechanical contacts to be closed when the DC voltage has a value equal to or smaller than the predetermined value. When relay contacts are used as the first and second mechanical contacts, a relay drive circuit may be used as the driving means. A self-enabling semiconductor switching device is connected between the second-polarity power supply input terminal of the first inverter and the first-polarity power supply input terminal of the second inverter. The self-enabling semiconductor switching device is connected in such a manner that it is closed when the first and second mechanical contacts are opened, and is opened when the first and second mechanical contacts are closed. A self-enabling semiconductor switching device is a semiconductor switching device which has two terminals and conducts current therethrough between the two terminals when a voltage difference between the two terminals exhibits a predetermined positive or negative polarity and the absolute value of the voltage difference is equal to or larger than a predetermined value. When the absolute value of the voltage difference decreases below the predetermined value, the self-enabling semiconductor switching device becomes nonconductive. A diode may be used as the self-enabling semiconductor switching device.

With this arrangement of the power supply apparatus, the self-enabling semiconductor switching device is opened when the first and second mechanical contacts are closed, whereby the two inverters are connected in parallel. When the first and second mechanical contacts are opened, the self-enabling semiconductor switching device is closed, whereby the two inverters are connected in series. Thus, the inverters are connected in series or parallel in accordance with the magnitude of the DC voltage between the DC power supply terminals.

Even if the casing of the power supply apparatus falls down or strong impact, vibration or shaking is given to the casing, the self-enabling semiconductor switching device never changes from the closed state to the open state, or from the open state to the closed state. Accordingly, if the first and second mechanical contacts are closed, the self-enabling semiconductor switching device is open, but the self-enabling switching device is never closed even temporarily, and, therefore it never happens that the first and second mechanical contacts are damaged. If the first and second mechanical contacts are open, the self-enabling semiconductor switching device is closed, but it never happens that the self-enabling semiconductor switching device is opened even temporarily, and, therefore the power supply apparatus does not stop its operation.

When the first and second mechanical contacts are open, the self-enabling semiconductor switching device is closed. In this state, if the first and second mechanical contacts are temporarily made closed, the self-enabling semiconductor switching device is opened. Accordingly, neither of the first and second inverters is short-circuited.

For providing the DC voltage between the first and second DC power supply terminals, rectifying means may be used. One of the output terminals of the rectifying means is connected to the first DC power supply terminal, and the other output terminal of the rectifying means is connected to the second DC power supply terminal. One of first and second AC voltages is applied to an input terminal of the rectifying means. The second AC voltage has a value larger than the first AC voltage. The driving means drives the first and second mechanical contacts to close when the AC voltage at the input terminal of the rectifying means is the first AC voltage, and drives the first and second mechanical contacts to open when the AC voltage at the input terminal of the rectifying means is the second AC voltage.

With this arrangement, the power supply apparatus can be used with either one of two different AC voltages supplied to the power supply apparatus. Further, the first and second mechanical contacts can be switched depending on the value of the applied AC voltage.

### BRIEF DESCRIPTION OF DRAWINGS

FIG. 1 is a block circuit diagram of a power supply apparatus according to an embodiment of the present invention, with a 400 V level voltage supplied thereto.

FIG. 2 is a block circuit diagram of part of the power supply apparatus of FIG. 1 where a 200 V level voltage is being applied to the power supply apparatus.

FIG. 3 is a block circuit diagram of part of the power supply apparatus of FIG. 1 where a relay contact 26 is closed while a 400 V level voltage is being applied to the power supply apparatus.

FIG. 4 is a block circuit diagram of part of the power supply apparatus of FIG. 1 where a relay contact 26 is open while a 200 V level voltage is being applied to the power supply apparatus.

### EMBODIMENTS OF INVENTION

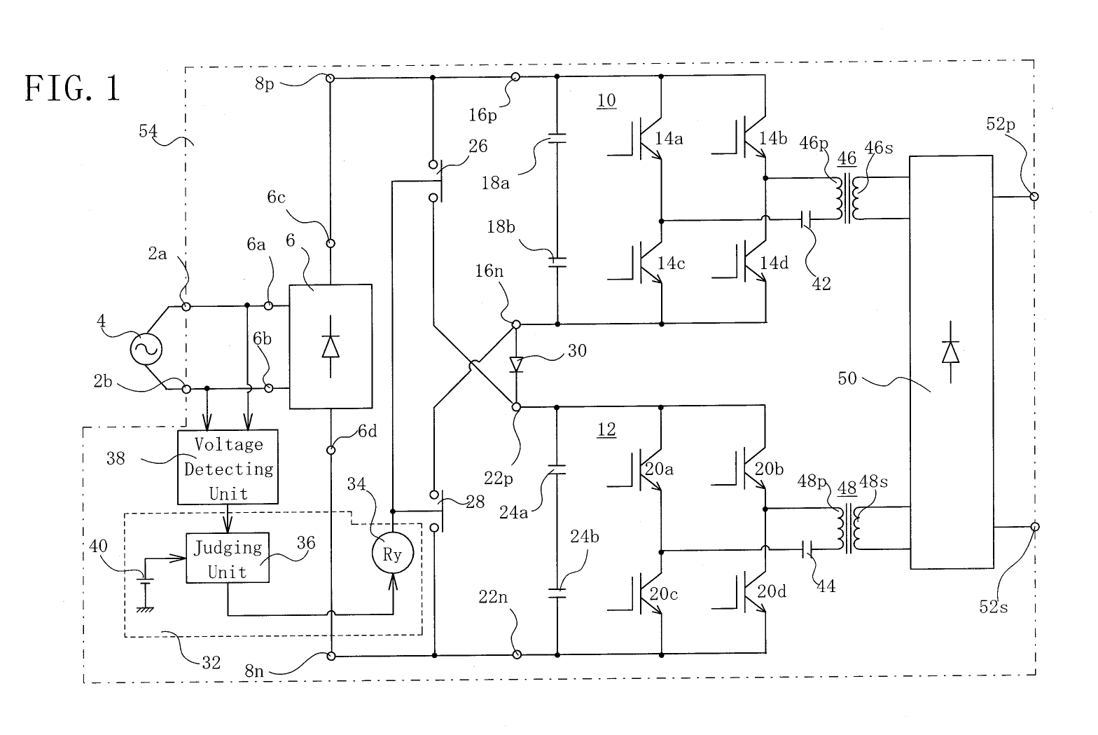

A power supply apparatus according to an embodiment of the present invention is for use with, for example, a welding machine, and includes two AC power supply terminals 2a and 2b, as shown in FIG. 1. A single-phase AC power supply 4 is connected to the AC power supply terminals 2a and 2b. The single-phase AC power supply 4 provides either a first AC voltage, for example, a 200 V level voltage, e.g. an AC voltage of 200 V, or a second AC voltage, for example, a 400 V level voltage, e.g. an AC voltage of 400 V. A 200-V level voltage is a voltage equal to and higher than 200 V and lower than 300 V, and a 400-V level voltage is a voltage equal to and higher than 400 V and lower than 500 V.

The AC power supply terminals 2a and 2b are connected respectively to two input terminals 6a and 6b of rectifying means, e.g. a rectifier circuit 6. The rectifier circuit 6 rectifies the AC voltage supplied thereto through the input terminals 6a and 6b and develops a rectified voltage between a positive output terminal 6c and a negative output terminal 6d. The rectifier circuit 6 may include a smoothing capacitor. The positive output terminal 6c of the rectifier circuit 6 is connected to a first one of DC power supply terminals, e.g. a positive DC power supply terminal 8p, while the negative output terminal 6d is connected to a second one of the DC power supply terminals, e.g. negative DC power supply terminal 8n. Two inverters 10 and 12 are connected between the positive and negative DC supply terminals 8p and 8n.

The inverter 10 includes four semiconductor switching devices, e.g. IGBTs 14a, 14b, 14c and 14d, connected in a full-bridge circuit configuration. A positive one of the two input sides of the full-bridge circuit is connected to a power supply terminal 16p of first polarity, e.g. positive polarity, and the negative input side of the full-bridge circuit is connected to a power supply terminal 16n of second polarity, e.g. negative polarity. Capacitors 18a and 18b are connected in series between the positive and negative power supply input terminals 16p and 16n.

The inverter 12, too, includes four semiconductor switching devices, e.g. IGBTs 20a, 20b, 20c and 20d connected in a full-bridge circuit configuration. A positive one of the two input sides of this full-bridge circuit is connected to a power supply terminal 22p of first polarity, e.g. positive polarity, and the negative input side of the full-bridge circuit is connected to a power supply terminal 22n of second polarity, e.g. negative polarity. Capacitors 24a and 24b are connected in series between the positive and negative power supply input terminals 22p and 22n.

The positive power supply input terminal 16p of the inverter 10 is connected to the positive DC power supply terminal 8p and also to the positive power supply input terminal 22p of the other inverter 12 through a mechanical contact, e.g. a relay contact 26. The negative power supply input terminal 22n of the inverter 12 is connected to the negative DC power supply terminal 8n and also to the negative power supply input terminal 16n of the inverter 10 through a mechanical contact, e.g. a relay contact 28.

A self-enabling semiconductor switching device, e.g. a diode 30, is connected between the negative power supply input terminal 16n of the inverter 10 and the positive power supply input terminal 22p of the inverter 12. The diode 30 has its anode connected to the negative power supply input terminal 16n and has its cathode connected to the positive power supply input terminal 22p. The diode 30 is conductive when the voltage at the negative power supply input terminal 16n is more positive, by a value equal to or larger than a threshold value, than the voltage at the positive power supply input terminal 22p. Otherwise, the diode 30 is non-conductive.

The relay contacts 26 and 28 are closed when a drive command is provided to a relay drive circuit 34 in driving means, e.g. a driving unit 32. Otherwise, the relay contacts 26 and 28 are open. The drive command to the relay drive circuit 34 is provided from a judging unit 36. The judging unit 36 is provided with a detected-voltage-representative signal generated by a voltage detecting unit 38. The detected-voltage-representative signal represents the value of the AC voltage supplied between the AC power supply terminals 2a and 2b. The judging unit 36 is also provided with a reference signal from a reference signal source 40. The reference signal has a value intermediate between the value of the detected-voltage-representative signal corresponding to the AC voltage of 200 V and the value of the detected-voltage-representative signal corresponding to the AC voltage of 400 V. The judging unit 36 supplies the drive command to the relay drive circuit 34 when the detected-voltage-representative signal from the voltage detecting unit 38 is equal to or smaller than the reference signal. Thus, when the AC voltage of 400 V is supplied between the AC power supply terminals 2a and 2b, the relay contacts 26 and 28 are opened, and when the AC voltage of 200 V is supplied between the AC power supply terminals 2a and 2b, the relay contacts 26 and 28 are closed.

The inverter 10 has its IGBTs 14a-14d ON-OFF controlled in accordance with a control signal from a control circuit (not shown), which causes the DC voltage applied between the positive and negative power supply input terminals 16p and 16n to be converted to a high-frequency voltage. The inverter 12 operates in a similar manner. The outputs of the inverters 10 and 12 are connected respectively to primary windings 46p and 48p of respective voltage transformers 46 and 48 through associated capacitors 42 and 44. The secondary windings 46s and 48s of the transformers 46 and 48 are connected to a rectifier circuit 50. The output of the rectifier circuit 50 is supplied to positive and negative output terminals 52p and 52n which are to be connected to a load, e.g. a welder load.

The power supply apparatus is housed in a casing 54.

With the above-described arrangement of the power supply apparatus, the relay drive circuit 34 causes the relay contacts 26 and 28 to be opened as shown in FIG. 1 when the AC power supply 4 supplies a voltage of 400 V. As a result, a voltage resulting from rectifying the 400 V AC voltage is developed between the positive and negative DC power supply terminals 8p and 8n, so that the voltage at the anode of the diode 30 becomes higher than the voltage at the cathode of the diode 30. This makes the diode 30 conductive, and the inverters 10 and 12 operate, being connected in series with each other.

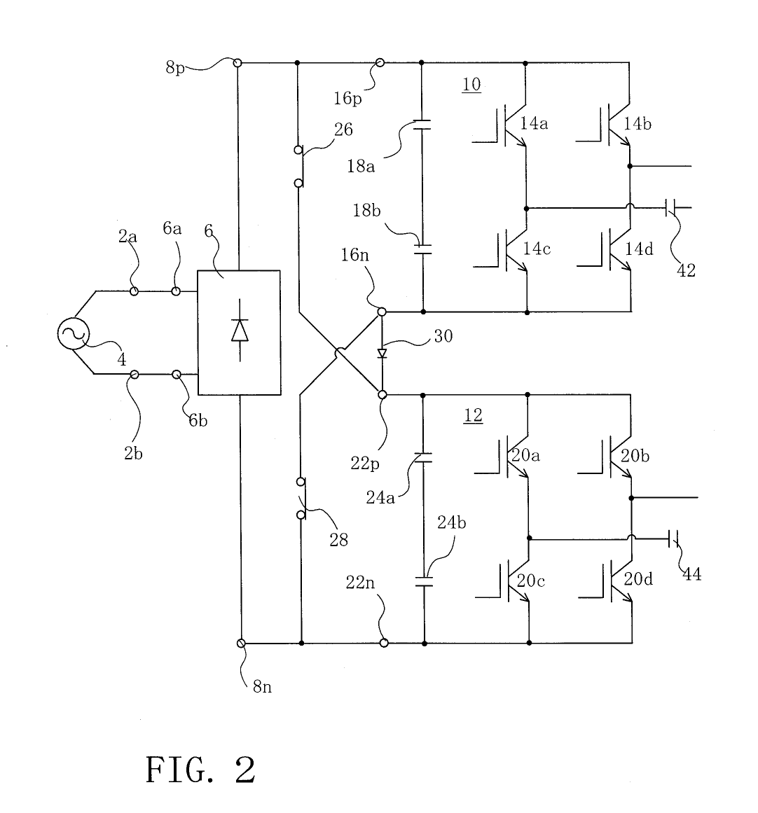

When a voltage supplied from the AC power supply 4 is at 200 V, the judging unit 36 supplies a drive command to the relay drive circuit 34 to cause the relay contacts 26 and 28 to be closed as shown in FIG. 2. In this state, the cathode voltage of the diode 30 is higher than the anode voltage, and therefore, the diode 30 is nonconductive. As a result, the inverters 10 and 12 are connected in parallel and operate from a voltage resulting from rectifying the 200 V AC voltage applied between the positive and negative DC power supply terminals 8p and 8n.

When the casing 54 containing the power supply apparatus, with the relay contacts 26 and 28 opened and with the diode 30 conductive, as shown in FIG. 1, falls or when a strong impact or shaking is given to the casing 54, the diode 30 is not made nonconductive by such fall-down, impact or shaking because the diode 30 is not a mechanical switch. Thus, such accident does not abruptly stop the operation of the power supply apparatus.

Also, when the casing 54 containing the power supply apparatus, with the relay contacts 26 and 28 closed and with the diode 30 nonconductive, as shown in FIG. 2, falls or a strong shock or shaking is given to the casing 54, the diode 30 is not made conductive by such fall-down, shock or shaking. Accordingly, it never happens that the positive and negative DC power supply terminals 8p and 8n are short-circuited. Thus, even if such accident occurs, no short-circuit current flows through the relay contacts 26 and 28 and the diode 30, and the relay contacts 26 and 28 are not damaged by such accident.

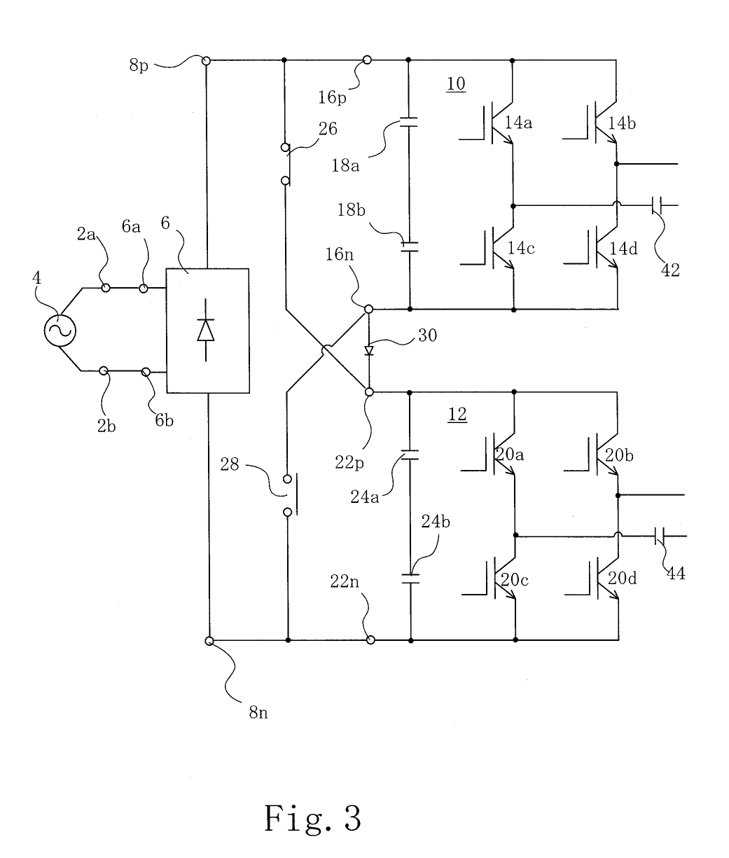

In a state where the relay contacts 26 and 28 are open and the diode 30 is conductive, if the casing 54 containing the power supply apparatus falls or if a strong shock or shaking is given to the casing 54, causing one of the relay contacts 26 and 28, the contact 26, for example, to be temporarily closed, as shown in FIG. 3, the cathode voltage of the diode 30 becomes higher than the anode voltage, making the diode 30 nonconductive. This prevents the inverter 10 from being short-circuited, and therefore, the inverter 10 is not damaged. Similarly, if the relay contact 28, instead of the relay contact 26, is temporarily closed, the inverter 12 is never damaged, either.

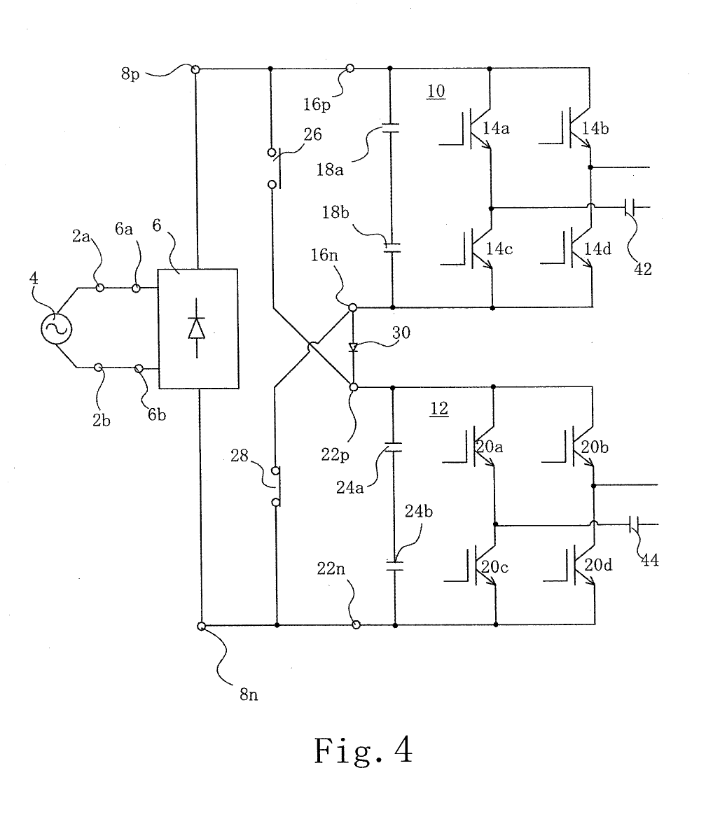

In a state where the relay contacts 26 and 28 are closed and the diode 30 is nonconductive, if the casing 54 containing the power supply apparatus falls or if a strong impact or shaking is given to the casing 54, causing one of the relay contacts 26 and 28, for example, the relay contact 26, to be temporarily opened, as shown in FIG. 4, the inverter 12 stops operating and only the inverter 10 operates. If such state continues long, only the inverter 10 supplies current to the load, causing increase of current flowing through the inverter 10, which could damage the inverter 10, but, if the opening of the relay contact 26 is for a short time, the inverter 10 is not damaged. Under normal operating states, if abnormal current flows, current detecting means (not shown) operates to detect such abnormal current to make the power supply apparatus stop operating. Similar operation takes place when the relay contact 28 is opened temporarily.

As described above, the use of the diode 30 can prevent the power supply apparatus from incurring fatal damages even if the casing 54 falls or if a strong impact or shaking is given to the casing 54.

The inverters 10 and 12 of the power supply apparatus according to the above-described embodiment are full-bridge type inverters, but the type of the inverters useable for the present invention is not limited to the full-bridge type, and inverters of the half-bridge type can be used, instead, for example. Also, although IGBTs are used as the semiconductor switching devices 14a-14d and 20a-20d of the inverters 10 and 12 in the above-described embodiment, other devices such as MOSFETs and bipolar transistors may be used instead. The power supply apparatus has been described as being for a welder, but it may be used as a power supply apparatus for other uses. Further, according to the described embodiment, the value of the AC voltage between the AC power supply terminals 2a and 2b is detected by means of the voltage detecting unit 38, the voltage between the positive and negative DC power supply terminals 8p and 8n may be detected instead, for the same purpose. Further, the single-phase AC power supply 4 has been described as providing either a 200 V level voltage or a 400 V level voltage, but an AC power supply providing other voltage, such as either one of a 200 V level voltage and a 600 V level voltage, or either one of a 400 V level voltage and a 600 V level voltage, may be used. Further, in place of the single-phase AC power supply 4, a three-phase AC power supply providing either of two different value three phase voltages may be used. In such case, the voltage detecting unit 38 can be arranged to detect a voltage between only two of the three output terminals of the three-phase AC power supply.

1. A power supply apparatus comprising:
first and second inverters each having a first-polarity power supply input terminal and a second-polarity power supply input terminal;
a first mechanical contact connected between said first-polarity power supply input terminals of said first and second inverters;
a second mechanical contact connected between said second-polarity power supply input terminals of said first and second inverters;
a first DC power supply terminal connected to said first-polarity power supply input terminal of said first inverter, and a second DC power supply terminal connected to said second-polarity power supply input terminal of said second inverter, a DC voltage being applied between said first and second DC power supply terminals;
driving means operating to open said first and second mechanical contacts when said DC voltage is larger than a predetermined value and close said first and second mechanical contacts when said DC voltage is not larger than said predetermined value; and
a diode connected between said second-polarity power supply input terminal of said first inverter and said first-polarity power supply input terminal of said second inverter, said diode being poled to be conductive when the voltage at the second-polarity power supply input terminal of said first inverter is higher than the voltage at the first-polarity power supply input terminal of said second inverter.

2. (canceled)

3. The power supply apparatus according to claim 1, further comprising rectifying means having one output terminal connected to said first DC power supply terminal, having the other output terminal connected to said second DC power supply terminal, and having an input terminal receiving one of first and second AC voltages, said second AC voltage having a value larger than the value of said first AC voltage; said driving means operating to close said first and second mechanical contacts when the AC voltage at the input terminal of said rectifying means is said first AC voltage, and to open said first and second mechanical contacts when the AC voltage at said input terminal of said rectifying means is said second AC voltage.

4. The power supply apparatus according to claim 1, wherein said first and second inverters, said first and second mechanical contacts, said driving means and said diode are housed in a casing, each of said first and second mechanical contacts, when said casing falls or when impact is given to said casing, is liable to temporarily change the state thereof from one of the open and closed states in which each of said mechanical contacts is, to the other of said open and closed states.
